(19) United States
(12) Patent Application Publication
(10) Pub. No.: US 2017/0085328 A1
(43) Pub. Date: Mar. 23, 2017

(54) MULTICHANNEL CONTENT DISTRIBUTION VIA SATELLITE TO BROADCAST-CAPABLE MOBILE NETWORKS

(71) Applicant: INTELSAT CORPORATION, McLean, VA (US)

(72) Inventors: Charles Edward DICKEMANN, Jr., McLean, VA (US); Christophe H.J. FONDIN, McLean, VA (US)

(73) Assignee: INTELSAT CORPORATION, McLean, VA (US)

(21) Appl. No.: 15/124,265

(22) PCT Filed: Mar. 31, 2015
(86) PCT No.: PCT/US15/23554

§ 371 Date: Sep. 7, 2016

Related U.S. Application Data
(60) Provisional application No. 61/972,548, filed on Mar. 31, 2014.
(60) Provisional application No. 62/035,148, filed on Aug. 8, 2014.

(51) Int. Cl. H04H 20/74; H04H 20/02; H04B 7/185; H04N 21/61; H04H 20/72

(52) U.S. Cl. CPC H04H 20/74; H04N 21/6131; H04N 21/6143; H04H 20/72; H04B 7/18586; H04H 20/02

(57) ABSTRACT

A method of delivering content, via a satellite, from a content server to one or more tower sites of a mobile operator network or locations with caching functions, the method including using satellite bandwidth of the satellite to transmit content to one or more tower sites of a mobile operator network, transmitting the content to the one or more tower sites or locations with caching functions using a combination of wide and spot beams based on locations of the one or more tower sites, and receiving distribution rules, with respect to the content, within computing resources on the downlink side of the transmission path in cloud-based architecture, and comprises transmitting the content to the one or more tower sites or caching locations based on the aggregated, received distribution rules and policies with further distribution to mobile devices.

### RELATED APPLICATIONS

This application claims priority from U.S. Provisional Patent Application No. 61/972,548, filed on Mar. 31, 2014 and from U.S. Provisional Patent Application No. 62/035,148 filed Aug. 8, 2014, in the United States Patent and Trademark Office, the disclosures of which are hereby incorporated herein in their entirety by reference.

### BACKGROUND

Technical Field

Systems and methods consistent with the present invention generally relate to multichannel content distribution via satellite to mobile networks and other last-mile networks that deliver content to a recipient of the content such as a consumer.

Description of the related art

In the related art, a content delivery method to individual devices (e.g., smartphones, laptops, tablets, and other connected devices) involves a one-to-one connection whether for linear or non-linear content (e.g., video). For example, as shown in FIG. 1, the related art content delivery method follows the following path.

(i) Content emanates from the broadcaster's origin server 1. If the origin server 1 is located at the content provider's site, it will be delivered to a processing unit 2 for processing such as Software as a Service (Saas), Digital Asset Management (Dig Asset Mgt), optimization, filtering, etc. After the processing, the processed content will be broadcast by a broadcaster 3. The origin server 1, processing unit 2, and broadcaster 3 could all be housed at the same location or located independently at separate locations.

(ii) Content is delivered via network such as Content Delivery Network (CDN) possibly using, but not limited to, fiber or copper to the mobile network core such as the Mobile Management Entity (MME) 4-1 or 4-2. Multiple MMEs 4 are needed due to the regionalization of content. In particular, regionalized content would represent separate connections from the origin server 1 at least to the target core aggregation point (MME 4)—meaning a one-to-one connection to each target location for each piece of content designated for regionalization.

(iii) At the MME core 4, each piece of content is distributed from the MME core 4 to each radio base station (cell tower site) 5 via a direct connection (e.g., a direct terrestrial or microwave connection).

(iv) At the tower site 5, a one-to-one connection is made with each device 6 to 6-n in the unicast model and the content is delivered to the respective device(s) 6 to 6-n. The amount of data corresponding to the delivered content is counted against the data plan of the user of the respective device(s) 6 to 6-n.

In a 4G network, the enhanced Multimedia Broadcast Multicast Services (eMBMS) can be used for the last mile distribution of the content (i.e., from the tower sites 5 to the devices 6). However, the eMBMS module within the 4G devices must be activated by the mobile network operator. The devices are shipped with the capability, however they are shipped with that capability inactive. Once eMBMS is activated, the network will deliver video as requested from each device. Should more than one device within a cell request the same video, the network will determine that sending the content to those multiple devices is more efficient using broadcast (instead of unicast) and will dynamically switch to eMBMS for delivery.

FIG. 2 shows a 4G example of a content delivery method to individual devices linear or non-linear content when the eMBMS standard is utilized. As shown in FIG. 2, the workflow path in the eMBMS context is as follows:

(i) Content emanates from the broadcaster's origin server 1.

(ii) Content is delivered via the network to the MME 4-1 or 4-2. As noted above, multiple MMEs 4 are needed due to the regionalization of content.

(iii) At the MME core 4, each piece of content is distributed from the MME core 4 to each radio base station (cell tower site) 5 via a direct connection.

(iv) At the tower site 5, content is integrated with the eMBMS standards, and then the tower site 5 uses a small slice of the mobile spectrum and emanates as a broadcast signal available for any eMBMS-activated device 6 to 6-n that is authenticated to receive the content. The content is joined in-progress as if one were tuning into a broadcast that is underway. In this case, the amount of data corresponding to the delivered content may not be counted against the data plan of the user of the respective device(s) 6 to 6-n based on a business model or contractual agreement.

### SUMMARY

In each of the aforementioned content delivery methods described with respect to FIGS. 1 and 2, regionalized content represents separate connections from the origin server 1 at least to the target core aggregation point (MME 4) and thus one-to-one connection to each target location for each piece of content designated for regionalization is needed. In the case of the current unicast delivery method (not using eMBMS) discussed with respect to FIG. 1, that one-to-one connection would exist all the way to each device 6.

Much of the content such as video being delivered from the origin server 1 to the devices 6 is load intensive. A further delivery burden is added when point-to-point connections are required for region-targeting (both FIGS. 1 and 2) or unicast delivery (FIG. 1) to devices 6/6-n. Much of the content is load intensive because content transmission (such as video) is burdensome on the backbone of the network (e.g., a terrestrial backbone) which includes the portion of the delivery path from the origin server (1) to the MME (4) and, additionally, from the MME (4) to each tower site (5), and also because the path to each individual tower (5) is unicast. Although the “tower site” is referred to in order to maintain consistency with mobile network terminology; the destination could also include an edge location such as an antenna mast, WiFi Hotspot location or any edge location that could receive and aggregate a satellite signal and re-transmit the content over the last mile to receiving wired or wireless devices. Examples could include, but are not limited to, cars, aircraft, ships, homes, etc. Subsequent uses of the description “tower” or “tower site” should be understood to include edge locations as described above.

A difference between the two existing delivery paths, discussed here, represents a significant distinction and advantage for satellite delivery to the edge (towers). Existing delivery methods (terrestrial, microwave or otherwise) use point to point connections and employ a myriad of servers and interfaces, often managed by different companies, to deliver content such as video content to the edge. Each of these connections and interfaces can (and do) add latency and degradation of quality into the distribution timeline and quality of experience.

For example, during the 2014 World Cup soccer tournament, there were many instances of significant latency; earlier in 2014, the same was true for streaming coverage of the NFL Super Bowl during which viewers of the stream experienced 15-45 seconds of latency. Contrast that delivery with satellite distribution that represents a single path from a content owner's origin server to the uplink over the satellite to the downlink antenna at the edge (tower). There are no additional interfaces, connections or companies' equipment involved. The quality is, therefore, maintained through the single delivery path, and the latency is measured in milliseconds.

Network load has been well documented as problematic for streaming video that commands high-concurrent viewership. There have been several instances of terrestrial network failures due to what has been reported as “traffic overload” or a “huge peak audience” of concurrent viewers. Most recently, a streaming failure interrupted the World Cup match between Brazil and Croatia.

The Wall Street Journal reported that traffic overload cast a spotlight on the limitations of terrestrial streaming of linear, highly-viewed events.

Also, representatives from HBOGo explained that the HBOGo crash during the finale of the show True Detective was due to “overwhelming popular demand.”

The same limitations that have caused the outages in these terrestrial examples affect the middle mile portion of the mobile networks—from the origin servers to the towers.

Additionally, mobile network operators continue to seek WiFi offload options for certain video delivery over the last mile because of their limited spectrum to reach users' devices.

Therefore, one of the objectives of the present application is to introduce methods and systems for delivering content (linear or non-linear) directly to the radio base station (tower) sites of a mobile operator's network, bypassing the need to use or upgrade the existing backhaul for distribution of the same large-size content to multiple sites simultaneously. Equally, the disclosed methods and systems takes advantage of (and integrate with) the eMBMS delivery over the last mile to devices.

Accordingly, a non-limiting embodiment provides a method of delivering content, via a geo-stationary or non-geo-stationary satellite, from a content server to one or more tower sites of a mobile operator network, the method including using satellite bandwidth of the satellite to transmit content to one or more tower sites of a mobile operator network.

The method may further include transmitting the content to one or more tower sites using a combination of traditional and high-throughput satellites and wide and spot beams based on locations of the one or more tower sites.

The method may further include receiving distribution rules with respect to the content, and transmitting the content comprises transmitting the content to one or more tower sites based on the received distribution rules.

The one or more tower sites may receive authentication data from the mobile operator network.

The one or more tower sites may distribute the content to one or more devices based on the received authentication data.

Another non-limiting embodiment provides an apparatus for delivering content, via a a geo-stationary or non-geo-stationary satellite using traditional or high-throughput designs and employing wide or spot-beams, from a content server to one or more tower sites of a mobile operator network, the apparatus including one or more processors, and memory storing executable instructions that, when executed by the one or more processors, causes the one or more processors to perform the function of using satellite bandwidth of the satellite to transmit content to one or more tower sites of a mobile operator network.

The memory may store further executable instructions that, when executed by the one or more processors, causes the one or more processors to perform the function of transmitting the content to the one or more tower sites using a combination of wide and spot beams based on locations of the one or more tower sites.

An interface will be provided at a Radio Access Network gateway towards a transmission satellite modem/RF hub. The modem frequency will be determined by the requested retransmission bandwidth, and also the number of feeds that are required towards each broadcast service area. At the remote site, a VSAT modem will be configured to receive the transmission and retransmit the broadcast using IP multicast technology towards the Radio Access Base Station. The Radio Access Base Station will have been preconfigured to request the broadcast stream and will retransmit the broadcast to the requested cell broadcast area/areas.

The memory may store further executable instructions that, when executed by the one or more processors, causes the one or more processors to perform the step of receiving distribution rules with respect to the content, and the transmitting the content comprises transmitting the content to the one or more tower sites based on the received distribution rules.

The one or more tower sites may receive authentication data from the mobile operator network.

The one or more tower sites may distribute the content to one or more devices based on the received authentication data.

In an alternative embodiment, an intelligent network may be provided which includes an apparatus and computing capabilities at both the transmit stage (uplink) and at the receive stage side (downlink) of the satellite transmission that can process and execute instructions for the delivery of content to one or more tower sites, to a caching function, to a private network cloud, or to a personal cloud that could be implemented as hardware, firmware, software or any combination thereof.

A satellite's global view of the entire network and destination locations along with the intelligent networking and computing capabilities allows more immediate evaluation of and response to popularity shifts based on the requests for content. Further, once evaluated, satellite's multicast ability allows any caches or storage devices to be updated at once. Multicast channels are configured to be transmitted across the satellite link to each downlink router at the same time. This contrasts with the unicast-based network that, because of the one-to-one connection, forces the cache-network relationship to be handled individually or independently.

### BRIEF DESCRIPTION OF THE DRAWINGS

The above and other features and advantages of the present invention will become more apparent by describing in detail exemplary embodiments thereof with reference to the attached drawings in which:

FIG. 1 shows a related art content delivery system, utilizing the unicast technique;

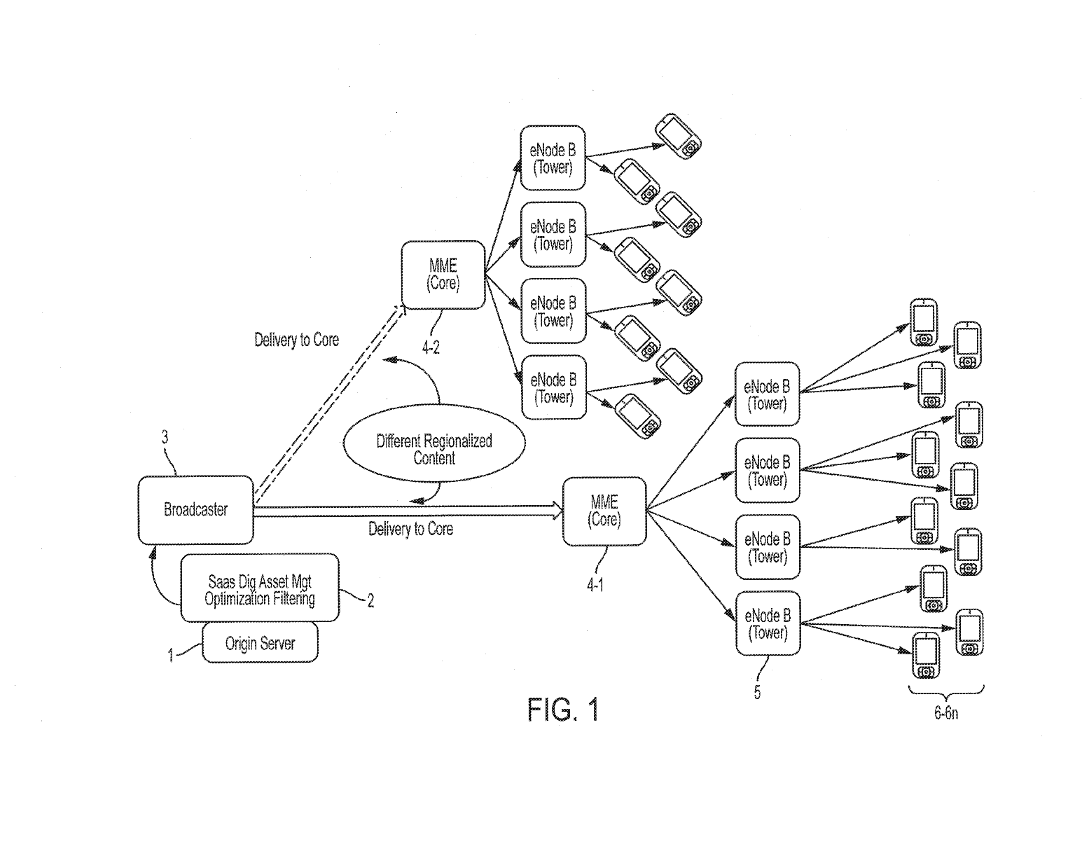

FIG. 2 shows a related art content delivery system, utilizing the eMBMS standard;

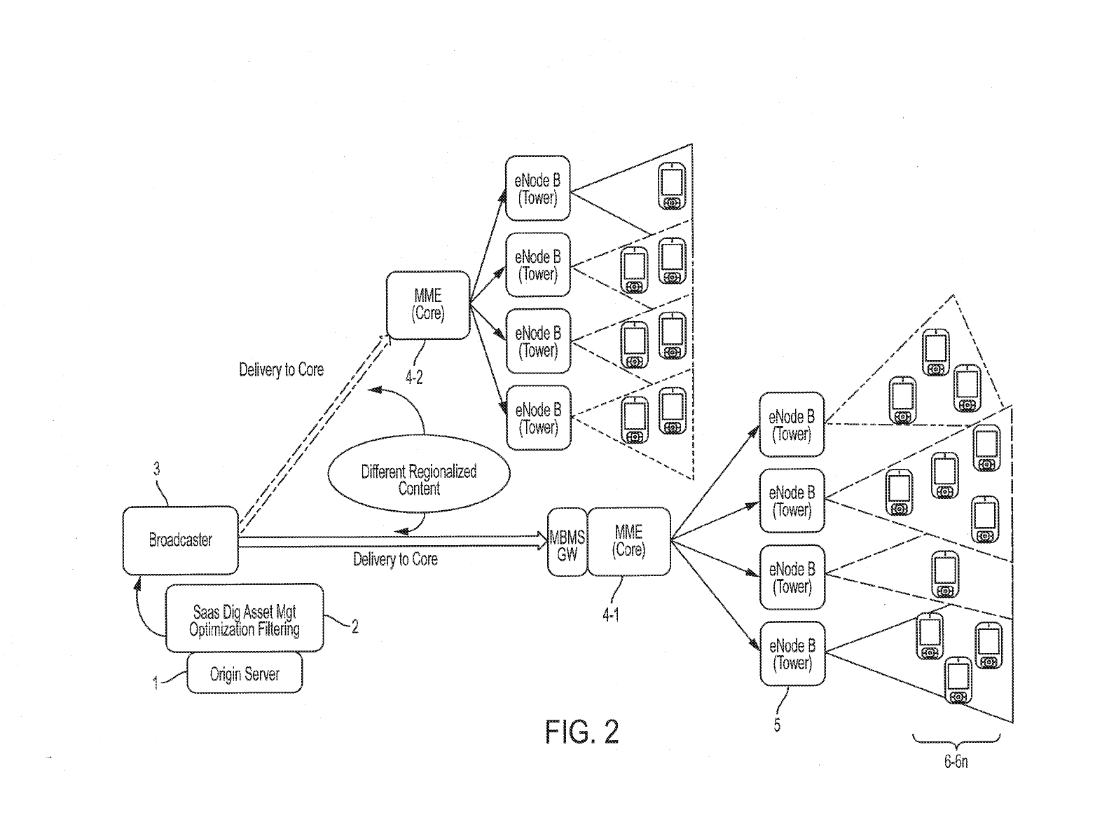

FIG. 3 shows a content delivery system, according to an exemplary embodiment;

FIG. 4 shows a content delivery system, according to yet another exemplary embodiment;

FIG. 5 shows the architecture of a tower site according to an exemplary embodiment; and

FIG. 6 illustrates a workflow process implemented using a content delivery system, according to yet another exemplary embodiment.

### DETAILED DESCRIPTION OF EXEMPLARY EMBODIMENTS

The following are explanations and/or definitions of names or descriptors as used in the exemplary embodiment. These are meant to aid the reader in understanding the descriptions of exemplary embodiments of the present invention and its components, design, use, and purpose. However, these terms should be entitled to their plain and ordinary meaning as understood by those of ordinary skill in the art.

Origin Server

The technical hardware that hosts content such as video files and represents the starting point in the workflow of delivering content.

Terrestrial Network

A network made up of various connections without the use of any wireless connections.

Mobile Network Core

The part of a mobile network that is the common terrestrial or microwave network used to distribute to the edge of the mobile network (such as towers) and prior to the Radio Access Network (final wireless coverage from the towers to the devices).

Tower Site

The mobile network's location of a cell tower.

Device (User Device)

Machine with cellular connection capability used to connect to the mobile network (e.g., smartphone, tablet, laptop, desktop computer, etc.).

Last Mile

The connection between the consumer and the telephone company, cable company, ISP or mobile company (e.g. from a cell tower to the user device).

Regionalization

The ability to target certain content to a specific geographic region based on distribution rules and policies.

Distribution Rules (and Policies)

The business-defined determination of where certain content can be distributed and where it must be restricted (e.g. sports coverage can be delivered to certain markets and not others, or certain content must not be delivered to certain countries due to cultural restrictions)

Authentication Data

The data used to determine that a user's device is authorized to receive certain content or service based on contractual arrangements or business decisions

Geo-Stationary and Non-Geo-Stationary Satellites

Geo-Stationary satellites (sometimes referred to as Geo-Synchronous) are satellites that orbit the earth at an altitude and a speed that allows the satellite to remain “fixed” in a particular location in orbit to provide ongoing service to a particular geographic region on the Earth. Sometimes these services are referred to as “FSS” (fixed satellite services). Non-Geo-Stationary satellites are satellites that are not located at an altitude and speed to remain stationary and whose coverage pattern may change. Examples include, but are not limited to, “MEO” (mid-earth orbit), “LEO” (low earth orbit) or “Inclined Orbit satellites” (that do not use onboard fuel for thrust to resist gravitational and magnetic-pole effects and remain stationary.)

Wide Beams

Wide beams (sometimes called Hemi Beams) generally cover large portions of a geographic area such as all of North America.

Spot Beams

Spot beams are focused on a much smaller geographic area or region and can restrict delivery to an individual country or region.

Teleport

The hosted facility that can house processing equipment for data and content (such as video content) and provide uplink and downlink services for satellite transport of data, content or communications.

Linear Content

Linear content progresses without any option for user control such as pausing or re-starting the video. Linear can be live content (such as a sporting event occurring now) or pre-recorded content slated to be delivered in its complete uninterrupted form starting at a specific time (such as a TV show's season premiere).

Non-Linear Content

Content that can be controlled (paused, re-started, viewed again, etc.) by the consumer. Examples of non-linear content are Video on Demand movies or You Tube clips.

Private Cloud

The unique combination of multicast satellite delivery capability with computing resources on the receive stage (downlink) side and closer to the consumer device that allows the aggregation of transmitted delivery rules and policies for the data or content as a function of delivery to an edge cache or mobile network tower. This private cloud could also host application software for the aggregation and compilation of user metrics (such as audience measurement) or deterministic data (such as how often a specific piece of content is being requested across all the edge caches) which can help define popularity trends and assist in prioritization of the purge/re-cache cycle.

Public Cloud Services

Commercial computing resources in data centers that contract with consumers or companies to store, archive and/or process data files and content. Examples include Amazon Web Services and Ultraviolet's digital locker. The Private Cloud could allow access to a public cloud's services while maintaining the security and reliability of a private network.

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

The use of satellite for delivery of content to the radio base stations (cell towers) should be effective for any generation of cellular networks. The subsequent multicast delivery of that content from the towers over the last mile to the devices will require broadcast capability such as that which is available in the 4G/LTE network and should be in subsequent generations of mobile networks (LTE Advanced, 5G, and beyond).

For purposes of this example, terminology used in the 4G/LTE network is referenced, although the disclosed embodiments are not limited to that network architecture.

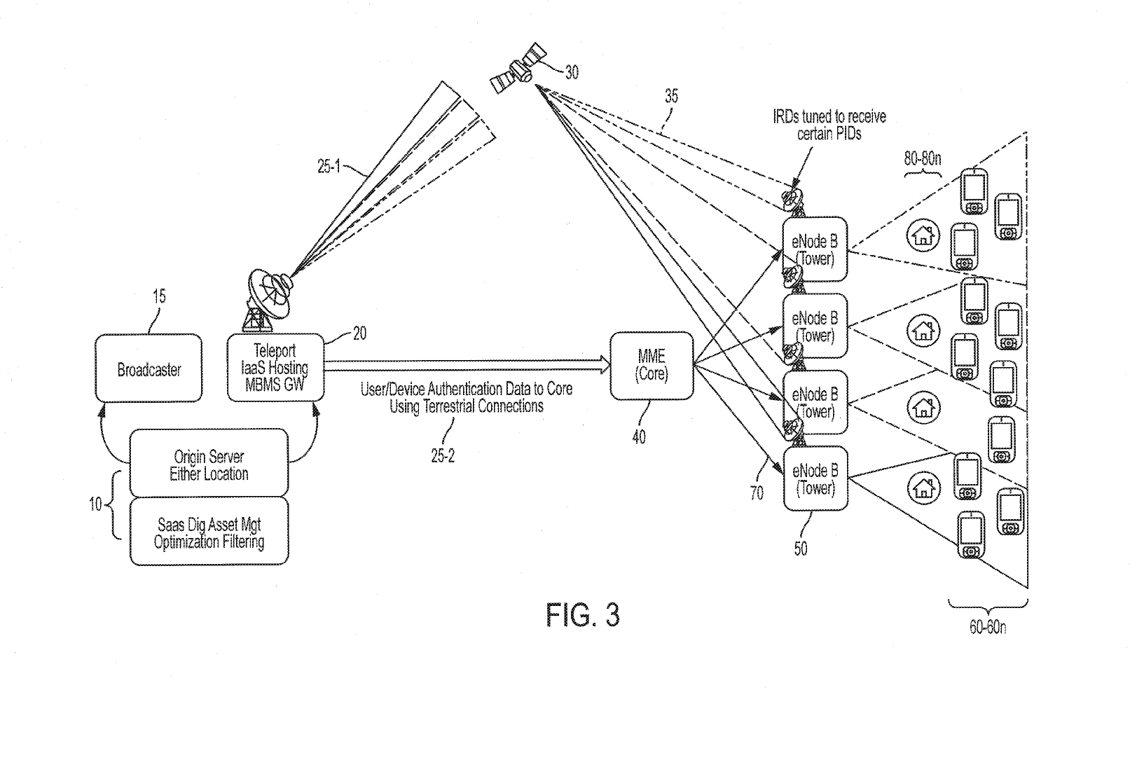

FIG. 3 shows a content delivery system, according to an exemplary embodiment. In this exemplary, non-limiting embodiment illustrated in FIG. 3, a content delivery system follows the following path:

(i) Content is retrieved from the origin server 10 of a broadcaster 15 or an aggregation site 20 such as a teleport serving as an Infrastructure as a Service (IaaS) where a hosted asset management application can assign distribution rules and policies to each piece of content as well as commercial material (both network and local inserts). Prior to distribution, content is linked with metadata that includes destination targets, digital rights management watermarks and other quality-control and processing codes. Aggregation of content in a more centralized environment prior to the uplink and the assignment of pre-determined distribution rules and policies and the subsequent satellite transmission to any point for last-mile distribution according to those rules could be significantly more efficient. Further, it would relieve the load from the mobile network by delivering video content directly to the mobile towers.

(ii) Content originates at the broadcaster's origin server 10 which can reside at the location of the broadcaster 15 or can be hosted at the teleport uplink facility 20. This metadata and digital content management for rules/policies (as described above) can be located with the origin server 10 or elsewhere prior to the uplink. Ultimately, the content is uplinked to a satellite 30 for multicast/broadcast distribution using a combination of wide and spot beams 25-1 to achieve regionalization to each tower site 50 based on the geo-targeting metadata. User/device authentication data 70 is sent to the MME 40 from the aggregation site 20 via the link 25-2.

(iii) On the receiving end (downlink), the IRD (integrated receiver decoder) of the tower site (e.g., including a satellite antenna) 50 is manually coded to recognize certain PIDs (packet IDs). These PIDs represent packets of data from the same stream for transport. The IRD's recognition of certain PIDs allows the satellite antenna (dish) to receive certain channels of content and not others. The content streams included in the wide and spot beams 35 which are received and decoded by the IRDs are then converted for and transmitted to the mobile network's radio access network (RAN) at the tower site 50.

With the proliferation of potential content piracy, broadcasters could utilize this application to mitigate the illegal acquisition and subsequent re-transmission of video. Terrestrial or microwave transport mechanisms rely on intermittent distribution servers to move content files from the origin server to a tower site. Each of these intermittent servers represents a potential piracy access point. As such, in step (iii) of the path discussed above, the transmission to the tower site 50, e.g., can be done using a private, secure, satellite-delivered communication path (with no piracy access points) to mitigate middle-mile content piracy issues.

(iv) At the tower site 50 (or other edge aggregation and re-transmission location), content is encoded/repackaged, integrated with the eMBMS (or other acceptable) standards and is merged with the authentication data 70 received from the mobile network (e.g., the MME 40) via the link 25-2. In particular, at the tower site 50, the content is decoded from the satellite signal, converted for the RAN and encoded/repackaged for distribution over the cellular signal's last mile to the consumer's device 60-60n. The signaling sent from the MME core 40 to each tower 50 is the user device authentication data 70 that allows the consumer's cell phone to connect to the mobile network at that tower site 50. The tower site 50 then uses a small slice of the mobile spectrum and emanates as a broadcast signal available for any eMBMS-activated device 60 to 60n that is authenticated to receive the content or within any of the registered home devices 80 to 80-n. The content is joined in-progress as if one were tuning into a broadcast that is underway.

Using the satellite 30 to transfer the content between the broadcaster's origin server 10 and the tower sites 50 bypasses the need to use or upgrade the existing backhaul for distribution of the same large-size content to multiple sites simultaneously (i.e. from the broadcaster's origin server to the MME, and then to the tower sites). Further, the solution takes advantage of (and integrates with) the eMBMS delivery over the last mile to devices.

Further, using the satellite 30 to distribute content from the broadcaster's origin server 10 using spot beams to programmed IRDs allows the distribution of regionally-specific content simultaneously. Without satellite, this distribution of regionalized content would require individual one-to-one connections from the origin server distribution point to each regional MME core. The use of satellite eliminates the need for multiple point-to-point ground segment connections and, instead, delivers discrete content to appropriate destinations simultaneously with a single combination of wide beams and spot beams.

Integration at the tower site 50 based on the data 70 allows the load-intensive content to be merged with the distribution policies and device authentication from the mobile network, such that the eMBMS broadcasted content can be received by the devices 60. Further, distribution could also include homes 80 to 80n and is not limited to out-of-home, mobile viewing.

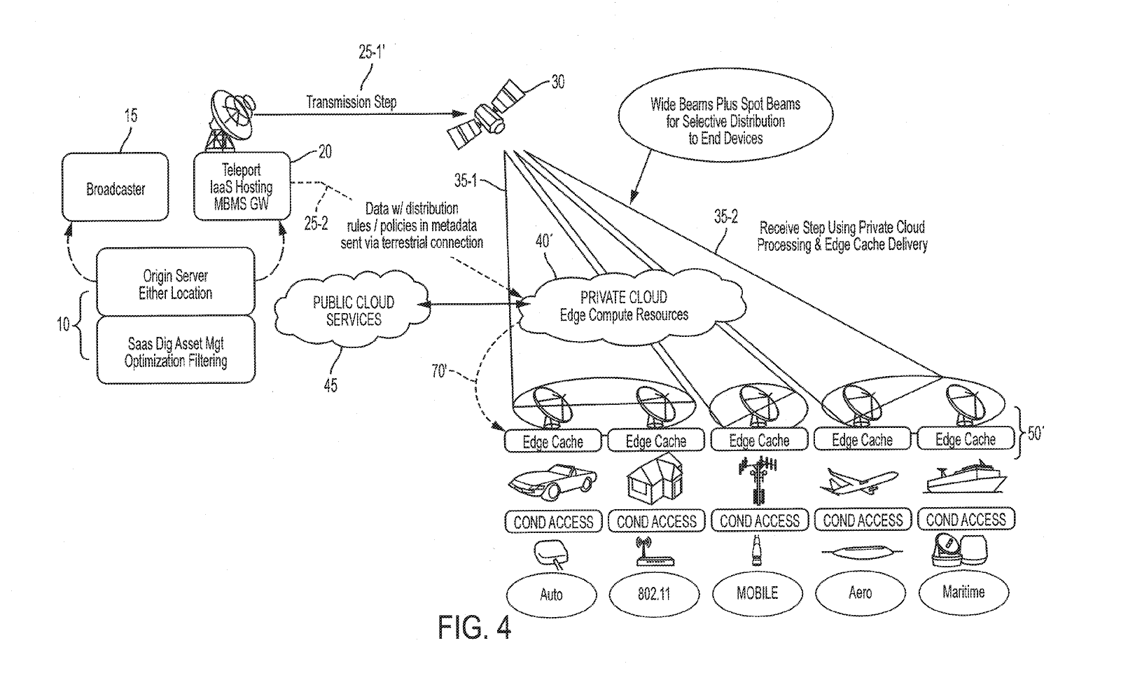

FIG. 4 shows a content delivery system, according to yet another exemplary embodiment. In this exemplary, non-limiting embodiment illustrated in FIG. 4, a content delivery system follows the following path:

(i) Content is retrieved from the broadcaster's origin server 10 or the aggregation site 20. Prior to distribution, content is linked with metadata that includes destination targets, digital rights management watermarks and other quality-control and processing codes.

(ii) Content originates at the broadcaster's origin server 10 which can reside at the broadcaster's location or can be hosted at the teleport uplink facility 20. This metadata and digital content management for rules/policies (as described above) can be located with the origin server 10 or elsewhere prior to the uplink. Ultimately, the content is uplinked to the satellite 30 for multicast/broadcast distribution using a combination of wide and spot beams 25-1′ to achieve regionalization to each site 50′ based on the geo-targeting metadata. User/device authentication data 70′ is sent to a Private Cloud 40′ from the aggregation site 20 via the link 25-2.

(iii) On the receiving end (downlink), if the site 50′ is a tower site such as the one shown in FIG. 3, the IRD (integrated receiver decoder) of the tower site (e.g., including a satellite antenna) is coded (e.g., manually coded) to recognize certain PIDs (packet IDs). The content streams included in the wide beam(s) 35-1 and/or spot beam(s) 35-2 which are received and decoded by the IRDs are then converted for and transmitted to the mobile network's RAN at the tower site.

On the other hand, if the site 50′ is another type of edge aggregation node such as a car, home, plane, or cruise ship as shown in FIG. 4, this edge aggregation node includes memory (e.g., hard drive, flash memory, etc.) for storing the received content streams included in the wide beam(s) 35-1 and/or spot beam(s) 35-2. For instance, the content could be stored at the edge aggregation node for a short or long period of time. Of course, the tower site would also include memory.

As discussed above with respect to FIG. 3, in step (iii), the transmission to the site 50′ can be done, e.g., using a private, secure, satellite-delivered communication path (with no piracy access points) to mitigate middle-mile content piracy issues.

(iv) The sites 50′ receive the authentication data 70′ from the Private Cloud 40′. In the case that the site 50′ is a tower site such as the one shown in FIG. 3, the content received from the beams 35-1 and/or 35-2 is encoded/repackaged, integrated with the eMBMS (or other acceptable) standards and is merged with the authentication data 70′ received from the Private Cloud 40′ for distribution over the cellular signal's last mile to the consumer device(s).

In this exemplary embodiment, if site 50′ is an edge aggregation node such as a car, home, plane, or cruise ship as shown in FIG. 4, the authentication data 70′ could be stored on the edge aggregation node temporarily or for a longer period of time. The content would decoded at the edge aggregation node from the satellite signal (beams 35-1 and/or 35-2) and merged with the authentication data 70′ received from the Private Cloud 40′ for providing conditional access at the edge aggregation node. Additionally, via the connection(s) of sites 50′ to the Private Cloud 40′, the Private Cloud 40′ could allow the sites 50′ access to services provided by a Public Cloud 45.

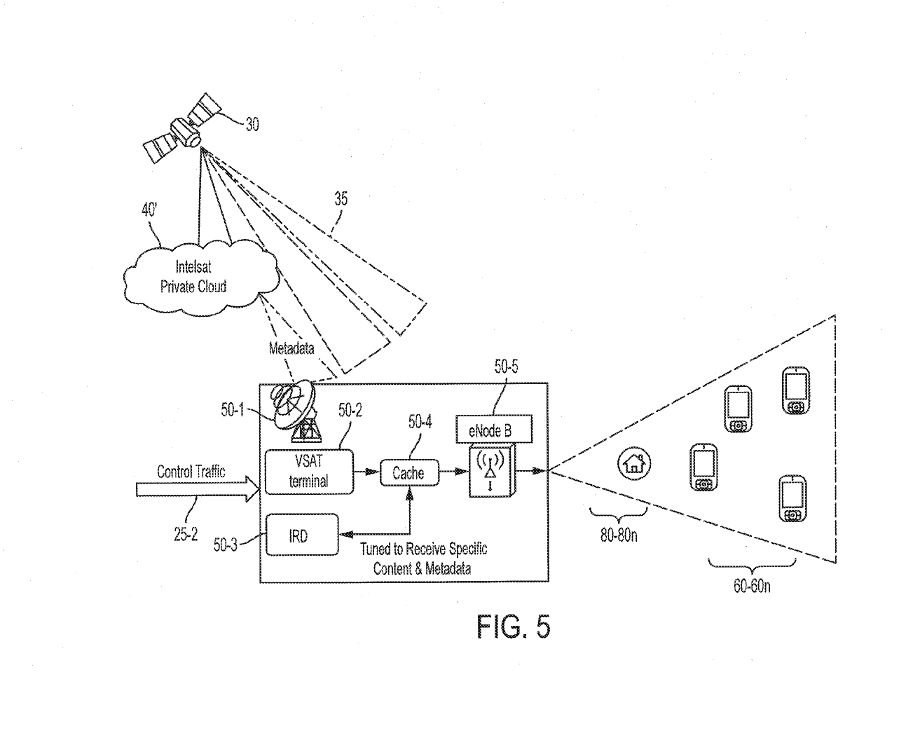

FIG. 5 shows the architecture of a tower site 50 according to an exemplary embodiment. The tower site includes a satellite antenna 50-1, a VSAT terminal 50-2, an IRD 50-3, a cache 50-4, and eNodeB along with an integrated or standalone site router/modem 50-5.

The satellite antenna 50-1 receives the beams 35 (signals) including the content transmitted from the satellite 30. The VSAT terminal 50-2 processes the signals received by the satellite antenna 50-1 to retrieve the content included therein. The IRD 50-3 receives the authentication data received via the link 25-2. Both the content retrieved by the VSAT terminal 50-2 and the authentication data received by the IRD 50-3 are stored in the cache 50-4. The eNodeB along with the integrated or standalone site router/modem 50-5 may retrieve the content and authentication data stored at the cache 50-4 and transmit the content to the mobile devices 60-60n or home devices 80-80n based on the authentication data. The transmission of the content could additionally be based on a request for content received from one or more of the mobile devices 60-60n and/or one or more of the home devices 80-80n.

The frequency of the modem 50-5 could be determined by the requested retransmission bandwidth, and also the number of feeds that are required towards each broadcast service area.

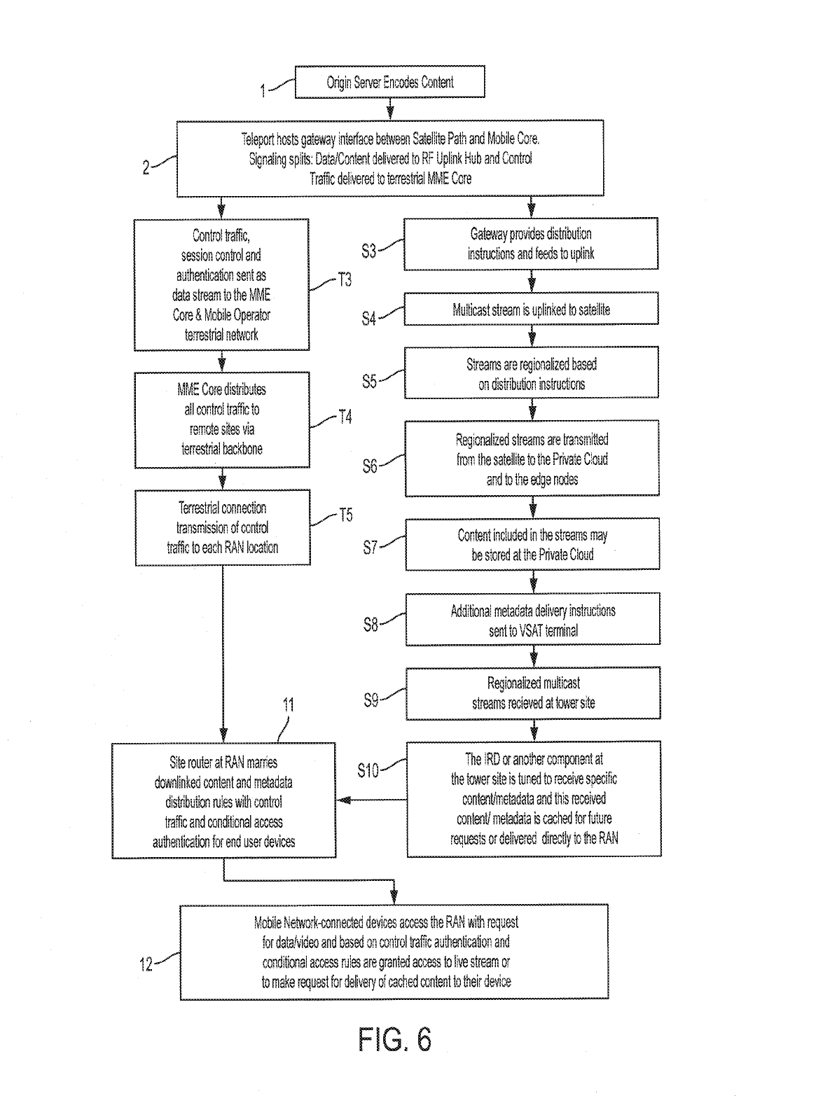

FIG. 6 illustrates a workflow process implemented using a content delivery system, according to yet another exemplary embodiment.

In this exemplary, non-limiting embodiment, an end user device (e.g., 60 or 80 in FIG. 3 or another type of an edge aggregation node included in a car/plane/cruise ship etc. as shown in FIG. 4) connects to a network (e.g., mobile network including MME core 40 in FIG. 3 or other types of network such as WiFi, Maritime, Aero, or Auto as shown in FIG. 4). Using a proprietary application or browser, the user may request for delivery of content (data/video). Control traffic authentication at the MME Core 40 or the edge aggregation node based on authentication data received by the MME Core 40 would validate the user as active user of network and other rules such as geographic authorization to access regionalized content, subscriber validation, or other conditional access verification. With successful completion of authentication and verification, the device ID associated with the user device may be allowed access by the MME Core 40 or the edge aggregation node to a live eMBMS stream, local cached content, or web access for content that is not locally cached.

The operations shown in FIG. 6 are not necessarily shown in the sequence in which they would be implemented. The operations could be implemented in a different sequential order, and one or more operations could be implemented in parallel.

In further detail, as shown in FIG. 6, at operation 1, the origin server 10 encodes content. At operation 2, the teleport 20 hosts a gateway interface between the satellite path to satellite 30 and the mobile core (MME Core 40). The teleport 20 may receive the encoded content from the origin server 10 in response to a request for content from end user device. Alternatively, the teleport may receive the encoded content from the origin server 10 in response to a scheduled update of a program or service at the user device (i.e., without an actual request for content from the end user device). Here, data/content may be delivered to an RF Uplink Hub and the control traffic may be delivered to the MME Core or Private Cloud terrestrially.

At operation T3, in the case of the tower site being a mobile operator network tower site (as opposed to another type of edge node), control traffic, session control, and authentication (Conditional Access, etc.) is sent as a data stream to the MME Core and the Mobile Operator terrestrial network.

At operation T4, the MME Core distributes all control traffic to the mobile operator network tower sites via the terrestrial backbone. As noted earlier, the data load of this control traffic is relatively low.

At operation T5, the control traffic is transmitted terrestrially to each RAN location in the respective tower site(s).

At operation S3, the gateway provides distribution instructions and feeds to the uplink.

At operation S4, a multicast stream including the distribution instructions and feeds may be uplinked to the satellite.

At operation S5, the streams may be regionalized at the satellite based on the distribution instructions.

At operation S6, the regionalized streams are transmitted from the satellite to the Private Cloud for potential archive storage and the regionalized streams are also transmitted to the edge nodes (e.g., including the tower site 50 and edge aggregation nodes other than the tower site 50).

At operation S7, a part of the content included in the streams or the entire content included in the streams may be received and stored at the Private Cloud. The Private Cloud is secure and can support multi-tenant customer storage.

At operation S8, additional metadata delivery instructions may be sent by the satellite to the VSAT terminal or another component included in the tower site/edge node.

At operation S9, regionalized multicast streams may be received at the tower site.

At operation S10, the IRD or another component at the tower site is tuned to receive specific content/metadata (e.g., the control traffic transmitted at operation T4), and this received content/metadata is either cached for future requests or delivered directly to the RAN for broadcast via eMBMS.

At operation 11, the site router at the RAN marries downlinked content and metadata distribution rules with control traffic and conditional access authentication for end user devices.

At operation 12, the mobile network connected devices (portable or home-based) access the RAN with request for data/video and based on control traffic authentication and conditional access rules, are granted access to live stream or to make request for delivery of cached content to their device.

The disclosed methods and systems utilize the inherent advantage of satellite delivery for broadcast using traditional and high-throughput designs as well as both wide-beams and spot-beam technologies.

The disclosed solution addresses:

1) the current dilemma of Mobile Network Operators experiencing a very competitive environment and forced to serve data hungry customers who currently use unicasts for streaming video on their 4G networks and, in doing so, increasingly stretching the capabilities of the mobile network;

2) the multicasting and broadcasting functionality within the protocols and signaling from the mobile network to the mobile subscriber devices (eMBMS); and

3) the role of satellite services to provide efficient, reliable and stable broadcast of high value content to end users or distributors of such contents (from “linear content” to less linear content broadcasting: ‘catch-up viewing’, upgrades, Video on Demand, etc.).

As described in detail earlier, the solution is achieved by directly delivering to a cell tower (e.g., tower site 50), the content to be provided to the mobile subscriber devices either a) by unicast/multicast if the content is stored in a caching function at the radio base station (cell tower site); or b) by multicast/broadcast, thus bypassing the need for the core function to distribute the same content via the unicast backhaul to each and every end point of the radio access network infrastructure.

The benefit of satellite delivery is in its ability to distribute data or content from one location to many locations simultaneously. In other words, multicast is superior to unicast in effective delivery of the same content to multiple locations. It also represents an efficient way to remove load-intensive data or content from a network backbone and distribute directly to edge locations.

Using high-throughput, spot-beam overlays may be used in conjunction with traditional satellites and wide beams to deliver specific content to specific locations based on policies, restrictions or popularity.

The network backbone benefits from both linear or non-linear distribution being removed and delivered by a more effective satellite mechanism. Furthermore, multicast delivery of non-linear content to a caching function offers efficiencies and further advantages using regionalization, throughput characteristics, and a network allowing for computing capabilities on the receive side of the transmission path.

The caching function could be located at the mobile network towers, but it is not limited to those locations. Caches could be hosted anywhere based on business determinations, economics and technology advancements. For example, storage could be hosted at satellite downlink sites, computing resources in a private enterprise network cloud, an aircraft, a cruise ship, municipal WiFi Hotspots, digital cinemas, or even a data center that hosts a consumer's private digital locker for content.

The efficiency of the multicast delivery mechanism using prescribed rules, policies and restrictions, employing an intelligent computing capability on the receive or downlink side of the satellite and removing the distribution from a network's backbone are some of the key benefits.

This method takes advantage of the intrinsic strength of satellite broadcast communications over a wide area and of the increased consumption of large data streams by the mobile subscribers in 4G, LTE Advanced, eventually 5G mobile networks and subsequent generations (hence the eMBMS innovation to broadcast content on a dedicated session/channel instead of unicasting the same content to each subscriber unit with a coverage area using discriminate delivery sessions).

The solution leverages satellite delivery as a differentiated backhaul method, relieving the mobile network operators of a documented congestion risk, and enhancing the experience and value of the services provided to subscribers (watching high quality live sport events for example) in a very competitive environment.

Finally, the consumer market may be drifting toward the individual's device becoming a personal “scheduler” with chosen content to be stored in a personal cloud for later viewing. As part of the solution development process, the integration between the satellite delivery, the mobile network and the authenticated device (or personal cloud) must be taken into account. Much like TiVo for a mobile device or tablet, and the storage location being a personal cloud, the authenticated stream may need to be archived in a virtual digital locker.

At least certain principles of the invention described above by way of non-limiting embodiments can be implemented as hardware, firmware, software or any combination thereof. Moreover, the software is preferably implemented as an application program tangibly embodied on a program storage unit, a non-transitory user machine readable medium, or a non-transitory machine-readable storage medium that can be in a form of a digital circuit, an analogy circuit, a magnetic medium, or combination thereof The application program may be uploaded to, and executed by, a machine comprising any suitable architecture. Preferably, the machine is implemented on a user machine platform having hardware such as one or more central processing units (“CPUs”), a memory, and input/output interfaces. The user machine platform may also include an operating system and microinstruction code. The various processes and functions described herein may be either part of the microinstruction code or part of the application program, or any combination thereof, which may be executed by a CPU, whether or not such user machine or processor is explicitly shown. In addition, various other peripheral units may be connected to the user machine platform such as an additional data storage unit and a printing unit.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of delivering content, via a satellite, from a content server to one or more edge locations of a mobile operator network, comprising:
using satellite bandwidth of the satellite to transmit content to the one or more edge locations of the mobile operator network.

2. The method of claim 1, further comprising:
transmitting the content to the one or more edge locations using a combination of traditional and high-throughput satellites and wide and spot beams based on locations of the one or more edge locations.

3. The method of claim 2, further comprising:
receiving distribution rules with respect to the content, and transmitting the content comprises transmitting the content to the one or more edge locations based on the received distribution rules.

4. The method of claim 2, wherein the one or more edge locations receive authentication data from the mobile operator network.

5. The method of claim 4, wherein the one or more edge locations distribute the content to one or more devices based on the received authentication data.

6. The method of claim 1, wherein the content is cached at the one or more edge locations.

7. An apparatus for delivering content, via a satellite, from a content server to one or more edge locations of a mobile operator network, comprising:
one or more processors;
memory storing executable instructions that, when executed by the one or more processors, causes the one or more processors to perform the function of:
using satellite bandwidth of the satellite to transmit content to the one or more edge locations of the mobile operator network.

8. The apparatus of claim 7, wherein the memory stores further executable instructions that, when executed by the one or more processors, causes the one or more processors to perform the function of:
transmitting the content to the one or more edge locations using a combination of wide and spot beams based on locations of the one or more tower sites.

9. The apparatus of claim 8, wherein the memory stores further executable instructions that, when executed by the one or more processors, causes the one or more processors to perform the function of:
receiving distribution rules with respect to the content, and the transmitting the content comprises transmitting the content to the one or more edge locations based on the received distribution rules.

10. The apparatus of claim 8, wherein the one or more edge locations receive authentication data from the mobile operator network.

11. The apparatus of claim 10, wherein the one or more edge locations distribute the content to one or more devices based on the received authentication data.

12. The apparatus of claim 7, wherein the content is cached at the one or more edge locations.
